(19) United States
(12) Patent Application Publication
(10) Pub. No.: US 2012/0254738 A1
(43) Pub. Date: Oct. 4, 2012

(54) TIME-SERIES INFORMATION GENERATING APPARATUS AND TIME-SERIES INFORMATION GENERATING METHOD

(75) Inventors: Kazuyo KURODA, Hino-shi (JP); Makito OGURA, Hino-shi (JP)

(73) Assignee: KABUSHIKI KAISHA TOSHIBA, Tokyo (JP)

(21) Appl. No.: 13/309,382

(22) Filed: Dec. 1, 2011

(30) Foreign Application Priority Data
Mar. 31, 2011 (JP) 2011-079329

(51) Int. Cl. G06F 17/00

(52) U.S. Cl. 715/254

(57) ABSTRACT

According to one embodiment, a time-series information generating apparatus includes a dividing module, a determining module, a generating module, and a display module. The dividing module divides an electronic document to be displayed into one or more sets of sentences. The determining module determines a summary of each of the sets of sentences. The generating module generates time-series information that represents relative temporal information between anyone of the sets of sentences and another set of sentences. The display module collectively displays the summary of each of the sets of sentences according to the time-series information.

### CROSS-REFERENCE TO RELATED APPLICATIONS

This application is based upon and claims the benefit of priority from Japanese Patent Application No. 2011-079329, filed Mar. 31, 2011, the entire contents of which are incorporated herein by reference.

### FIELD

Embodiments described herein relate generally to a time-series information generating apparatus and a time series information generating method.

### BACKGROUND

A technology has been disclosed in which, for each set of sentences in a text, time-series information is set in advance as the information representing relative temporal information among the sets of sentences. Such sets of sentences are displayed according to the time-series information set in advance.

In the conventional technology, the time-series information needs to be set in advance for each set of sentences in a text. If the time-series information is not set, the sets of sentences in the text cannot be displayed according to the time-series information.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an overall system configuration of a time-series information generating apparatus according to an embodiment;

FIG. 2 is an exemplary illustration diagram of the data configuration of text data according to the embodiment;

FIG. 3 is an exemplary illustration diagram of the data configuration of word importance data according to the embodiment;

FIG. 4 is an exemplary illustration diagram of the data configuration of temporal information data according to the embodiment;

FIG. 5 is an exemplary illustration diagram of the data configuration of time analysis data according to the embodiment;

FIG. 6 is an exemplary illustration diagram of the data configuration of character analysis data according to the embodiment;

FIG. 7 is an exemplary illustration diagram of the data configuration of text analysis data according to the embodiment;

FIG. 8 is an exemplary illustration diagram of the data configuration of character filtering setting data according to the embodiment;

FIG. 9 is an exemplary flowchart for explaining the sequence of operations performed during system processing in the time-series information generating apparatus according to the embodiment;

FIG. 10 is an exemplary flowchart for explaining the sequence of operation during a text analyzing operation performed in the time-series information generating apparatus according to the embodiment;

FIG. 11 is an exemplary flowchart for explaining the sequence of operations during a summary forming operation performed in the time-series information generating apparatus according to the embodiment;

FIG. 12 is an exemplary flowchart for explaining the sequence of operations during a temporal information generating operation performed in the time-series information generating apparatus according to the embodiment;

FIG. 13 is an exemplary flowchart for explaining the sequence of operations during a character information extracting operation performed in the time-series information generating apparatus according to the embodiment;

FIG. 14 is an exemplary flowchart for explaining the sequence of operations during a time-series information displaying operation performed in the time-series information generating apparatus according to the embodiment;

FIG. 15 is an exemplary illustration diagram of an example of a screen on which text analysis information is displayed;

FIG. 16 is an exemplary illustration diagram of an example of a screen on which text analysis information is displayed;

FIG. 17 is an exemplary illustration diagram of an example of a screen on which text analysis information is displayed;

FIG. 18 is an exemplary illustration diagram of an example of a screen on which text analysis information is displayed;

FIG. 19 is a flowchart for explaining the sequence of operations during a text displaying operation performed in the time-series information generating apparatus according to the embodiment; and

FIG. 20 is an illustration diagram of an example of a screen in which the text of an electronic document is displayed.

### DETAILED DESCRIPTION

In general, according to one embodiment, a time-series information generating apparatus comprises a dividing module, a determining module, a generating module, and a display module. The dividing module is configured to divide an electronic document to be displayed into one or more sets of sentences. The determining module is configured to determine a summary of each of the sets of sentences. The generating module is configured to generate time-series information that represents relative temporal information between any one of the sets of sentences and another set of sentences. The display module is configured to collectively display the summary of each of the sets of sentences according to the time-series information.

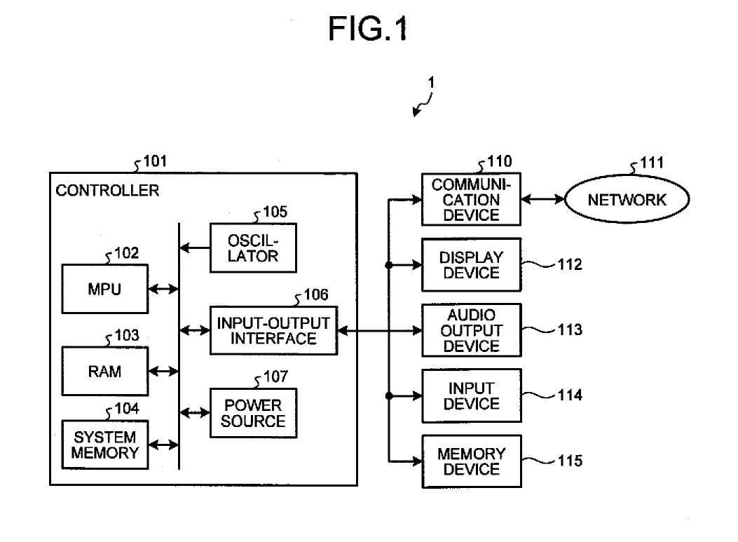

FIG. 1 is a block diagram of an overall system configuration of a time-series information generating apparatus according to an embodiment. A time-series information generating apparatus 1 of the embodiment comprises a controller 101 that controls the overall operation of the time-series information generating apparatus 1, a display device 112 that displays a variety of information such as information about sentences in an electronic document such as an electronic book to be displayed and the time-series information, an audio output device 113 that outputs audio, a communication device 110 that transmits/receives necessary information via a network 111 such as the Internet connection, an input device 114 that receives input of necessary information from the outside, and a memory device 115 that stores control programs and a various types of data.

The controller 101 comprises a micro processing unit (MPU) 102 that controls the overall operation of the time-series information generating apparatus 1, a random access memory (RAM) 103 that is used as a work area for the MPU 102 to execute various computer programs including control programs, a system memory 104 that is a nonvolatile memory such as a read only memory (ROM) or a hard disk drive (HDD) to store various computer programs executed by the MPU 102 and various types of information, a power source 107 that supplies power to the time-series information generating apparatus 1, an input-output interface 106 for performing input-output of information with the outside, and an oscillator 105 that performs system time settings and synchronization.

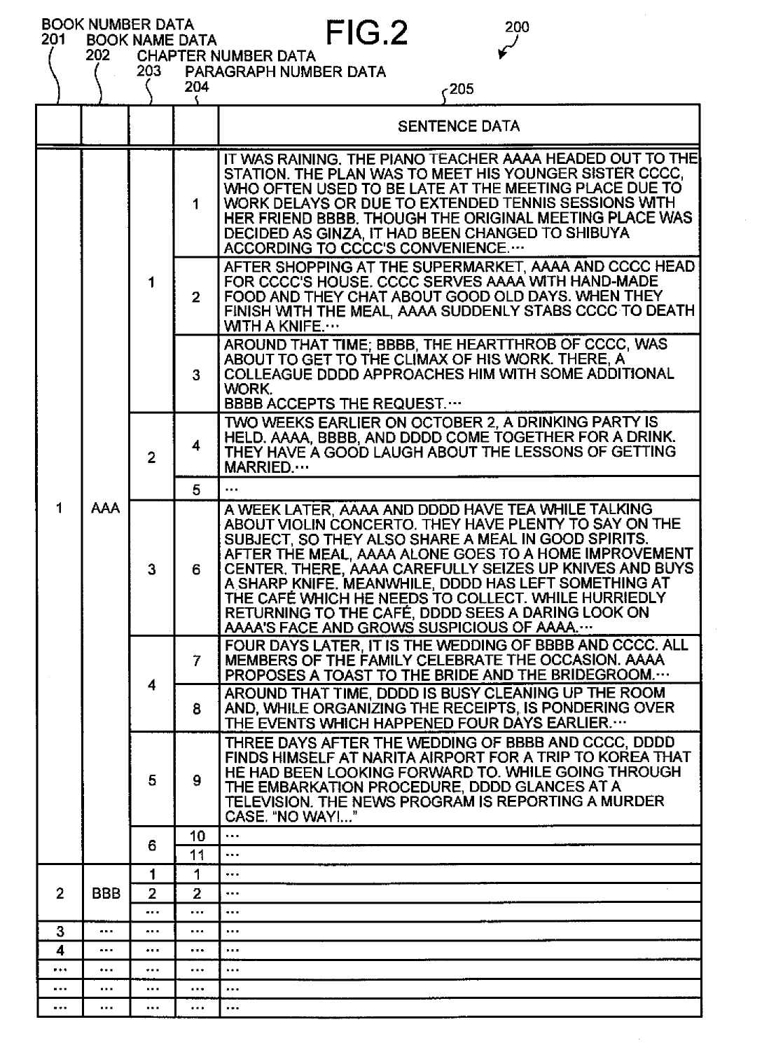

Explained below with reference to FIGS. 2 to 8 is an example of a variety of information stored in the system memory 104 of the controller 101.

FIG. 2 illustrates the data configuration of text data 200. The text data 200 contains book number data 201 having identification numbers for identifying electronic books that are electronic documents, book name data 202 having the name of each electronic book identified in the book number data 201, chapter number data 203 having identification numbers for identifying the chapters included in each electronic book that is identified in the book number data 201, paragraph number data 204 having identification numbers for identifying the paragraphs in each electronic book that is identified in the book number data 201, and sentence data 205 having a plurality of sets of sentences obtained by dividing the text on a paragraph-by-paragraph basis in each electronic book that is identified in the book number data 201. In the text data 200, the abovementioned data are associated with one another.

As described above, in the embodiment, the text data 200 of each electronic book is stored after dividing the text into a plurality of sets of sentences on a paragraph-by-paragraph basis of the electronic book. However, alternatively, it is also possible to store the text of each electronic book by dividing it on the basis of chapters, volumes, sentences, or books. Moreover, in the embodiment, although the text data 200 is stored in the system memory 104, it is also possible to obtain the text data 200 via a network. Furthermore, in the embodiment, although the text data 200 is used to store sentences of the text of electronic books, it is also possible to store electronic documents such as user diaries or arbitrary text in the text data 200.

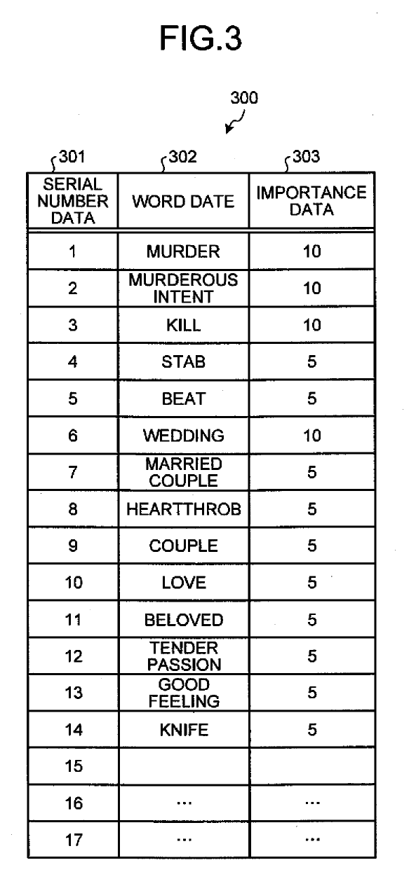

FIG. 3 illustrates the data configuration of word importance data 300. The word importance data 300 contains serial number data 301 having identification numbers for identifying words, word data 302 having words identified in the serial number data 301, and importance data 303 indicating the level of importance of each word specified in the word data 302. In the word importance data 300, the abovementioned data are associated with one another.

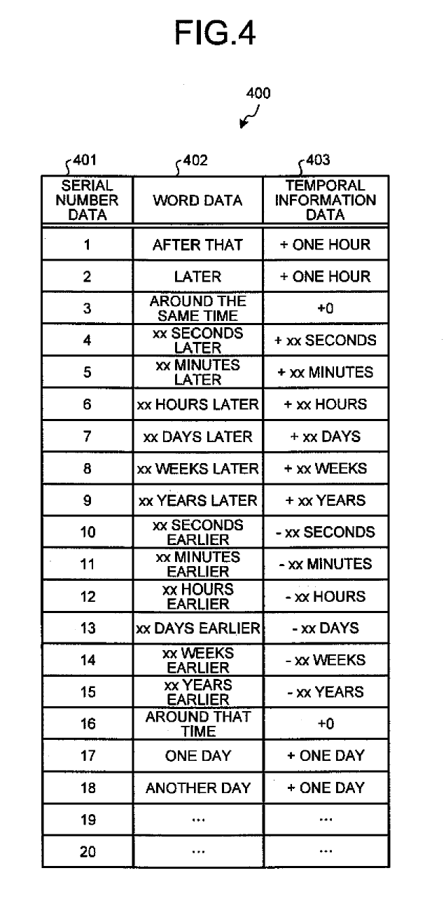

FIG. 4 illustrates the data configuration of temporal information data 400. The temporal information data 400 contains serial number data 401 having identification numbers for identifying temporal information, word data 402 having words representing the temporal information that is identified in the serial number data 401, and temporal information data 403 having the temporal information represented by each word that is specified in the word data 402. In the temporal information data 400, the abovementioned data are associated with one another. As described above, in the embodiment, the word data 402 of the temporal information data 400 contains words representing the temporal information that is specified in the temporal information data 403. However, alternatively, it is also possible to store expressions such as phrases representing the temporal information specified in the temporal information data 403.

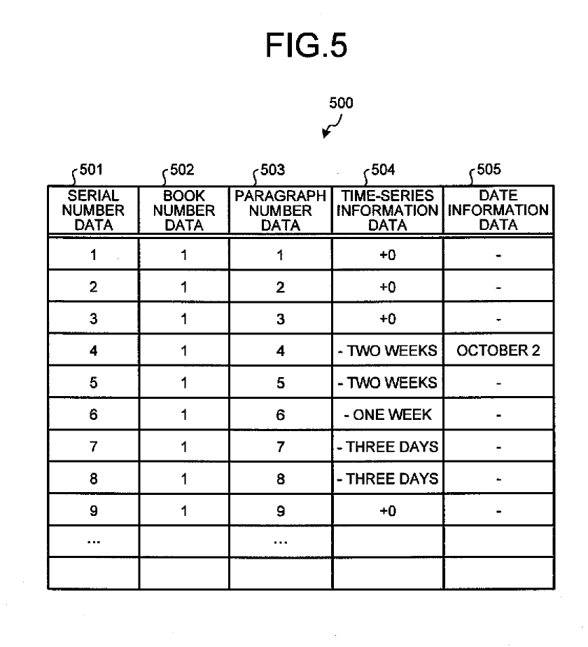

FIG. 5 illustrates the data configuration of time analysis data 500. The time analysis data 500 contains serial number data 501 having identification numbers for identifying date information that is represented by expressions such as words extracted from the sentence data 205 and for identifying time-series information that is generated for each set of sentences in the sentence data 205, book number data 502 having identification numbers for identifying electronic books containing such sets of sentences specified in the sentence data 205 from which are extracted the words representing the date information identified in the serial number data 501 (or electronic books containing such sets of sentences specified in the sentence data 205 from which is generated the time-series information), paragraph number data 503 having identification numbers for identifying paragraphs to each of which belongs such a set of sentences specified in the sentence data 205 from which are extracted the words representing the date information identified in the serial number data 501 (or paragraphs to each of which belongs such a set of sentences specified in the sentence data 205 from which is generated the time-series information), time-series information data 504 having time-series information generated regarding such sets of sentences specified in the sentence data 205 that belong to the paragraphs identified in the paragraph number data 503, and date information data 505 having date information represented by the words extracted from such sets of sentences specified in the sentence data 205 that belong to the paragraphs identified in the paragraph number data 503. In the time analysis data 500, the abovementioned data are associated with one another. Herein, the date information specified in the date information data 505 contains absolute dates represented by the words extracted from the sentences in the sentence data 205. In contrast, the time-series information data 504 contains relative temporal information between the sentences in the first paragraph and the sentences in each other paragraph.

That is, in the embodiment, that set of sentences in the sentence data 205 which belongs to the first paragraph is considered to be the reference point. Using that reference point, the time-series information in the time-series information data 504 represents relative temporal information between the sentences in the first paragraph and the sentences in each other paragraph. Hence, in the time analysis data 500, corresponding to the paragraph number “1” in the paragraph number data 503, the time-series information in the time-series information data 504 has “+0” stored therein in advance. As described above, in the embodiment, the time-series information data 504 contains relative temporal information between those sentences in the sentence data 205 which belong to the first paragraph and those sentences in the sentence data 205 which belong to the other paragraphs. However, that is not the only option as long as, from among the sentences in the sentence data 205 of a plurality of paragraphs extracted from the text, relative temporal information is given between those sentences in the sentence data 205 which belong to any particular paragraph and those sentences in the sentence data 205 which belong to the other paragraphs.

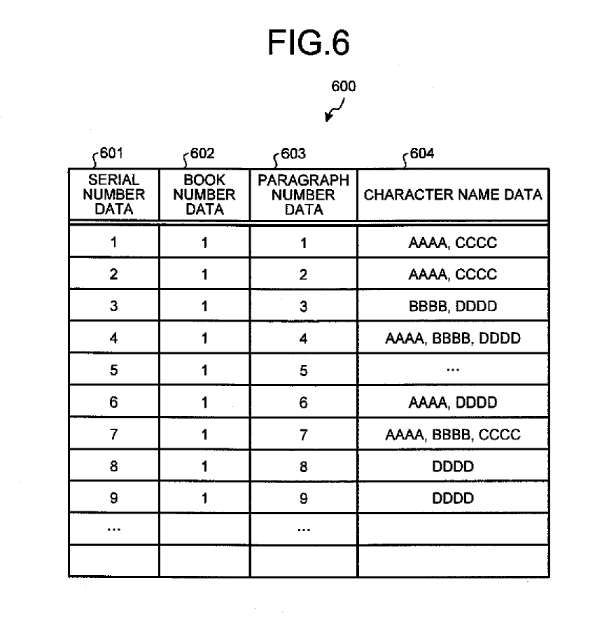

FIG. 6 illustrates the data configuration of character analysis data 600. The character analysis data 600 contains serial number data 601 having identification numbers for identifying character names that are extracted from the sentences specified in the sentence data 205, book number data 602 having identification numbers for identifying electronic books containing such sentences in the sentence data 205 from which are extracted the character names identified in the serial number data 601, paragraph number data 603 having identification numbers for identifying the paragraphs to which belong such sentences in the sentence data 205 from which are extracted the character names identified in the serial number data 601, and character name data 604 (character information) having names of characters that are extracted from such sentences in the sentence data 205 that belong to the paragraphs identified in the paragraph number data 603. In the character analysis data 600, the abovementioned data are associated with one another.

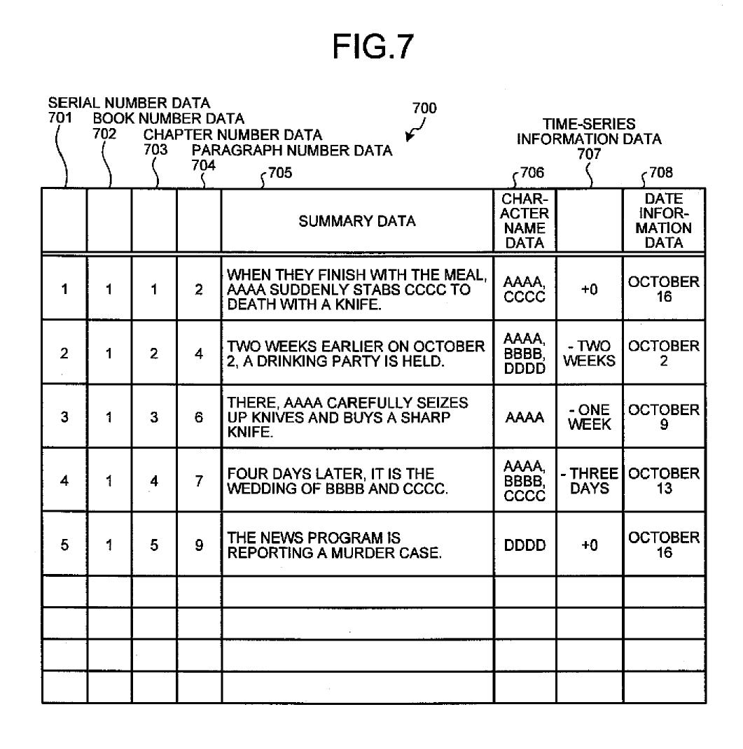

FIG. 7 is an illustration diagram of the data configuration of text analysis data. Herein, text analysis data 700 contains serial number data 701 having identification numbers for identifying text analysis information each set of which corresponds to the summary of a particular set of sentences in the sentence data 205, corresponds to character names extracted from that particular set of sentences in the sentence data 205, corresponds to the time-series information generated regarding that particular set of sentences in the sentence data 205, and corresponds to the date information represented by the words extracted from that particular set of sentences in the sentence data 205, book number data 702 having identification numbers for identifying electronic books that contain such sets of sentences in the sentence data 205 from which is generated the text analysis information identified in the serial number data 701, chapter number data 703 having identification numbers for identifying the chapters to which belong such sets of sentences in the sentence data 205 from which is generated the text analysis information identified in the serial number data 701, paragraph number data 704 having identification numbers for identifying the paragraphs to which belong such sets of sentences in the sentence data 205 from which is generated the text analysis information identified in the serial number data 701, summary data 705 having summaries formed from such sets of sentences in the sentence data 205 which belong to the paragraphs identified in the paragraph number data 704, character name data 706 (character information) having names of characters extracted from such sets of sentences in the sentence data 205 which belong to the paragraphs identified in the paragraph number data 704, time-series information data 707 having time series information generated from such sets of sentences in the sentence data 205 which belong to the paragraphs identified in the paragraph number data 704, and date information data 708 having date information represented by words that are extracted from such sets of sentences in the sentence data 205 which belong to the paragraphs identified in the paragraph number data 704. In the text analysis data 700, the abovementioned data are associated with one another.

Herein, the character names specified in the character name data 706 of the text analysis data 700 correspond to the character names specified in the character name data 604 of the character analysis data 600 illustrated in FIG. 6. Moreover, the time-series information data 707 and the date information data 708 of the text analysis data 700 correspond to the time-series information data 504 and the date information data 505 of the time analysis data 500 illustrated in FIG. 5.

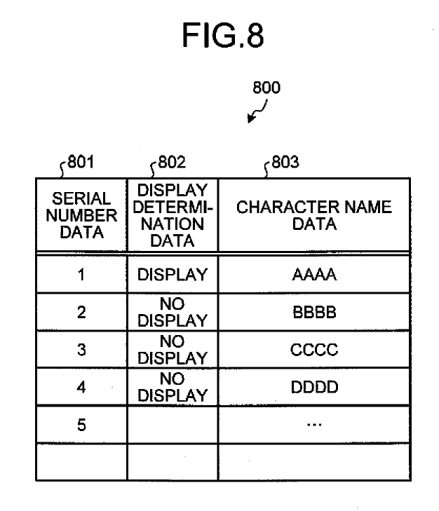

FIG. 8 illustrates the data configuration of character filtering setting data 800. The character filtering setting data 800 contains serial number data 801 having identification numbers for identifying character filtering setting that indicates whether or not to display such text analysis information that is associated with the character names set in advance in the character name data 706 from among the text analysis information (such as the summary data 705, the character name data 706, the time-series information data 707, and the date information data 708) generated from the sentences in the sentence data 205, display determination data 802 indicating whether or not to display the character filtering setting, and character name data 803 having character names that are extracted from the sentences specified in the sentence data 205. In the character filtering setting data 800, the abovementioned data are associated with one another. In the display determination data 802, “display” status indicates that, from among the summaries in the summary data 705, those summaries are to be displayed which are formed from such sets of sentences in the sentence data 205 that contain the subjects or objects representing character names corresponding to “display” status in the character name data 803. On the other hand, in the display determination data 802, “no display” status indicates that, from among the summaries in the summary data 705, those summaries are not to be displayed which are formed from such sets of sentences in the sentence data 205 that contain the subjects or objects representing character names corresponding to “no display” status in the character name data 803.

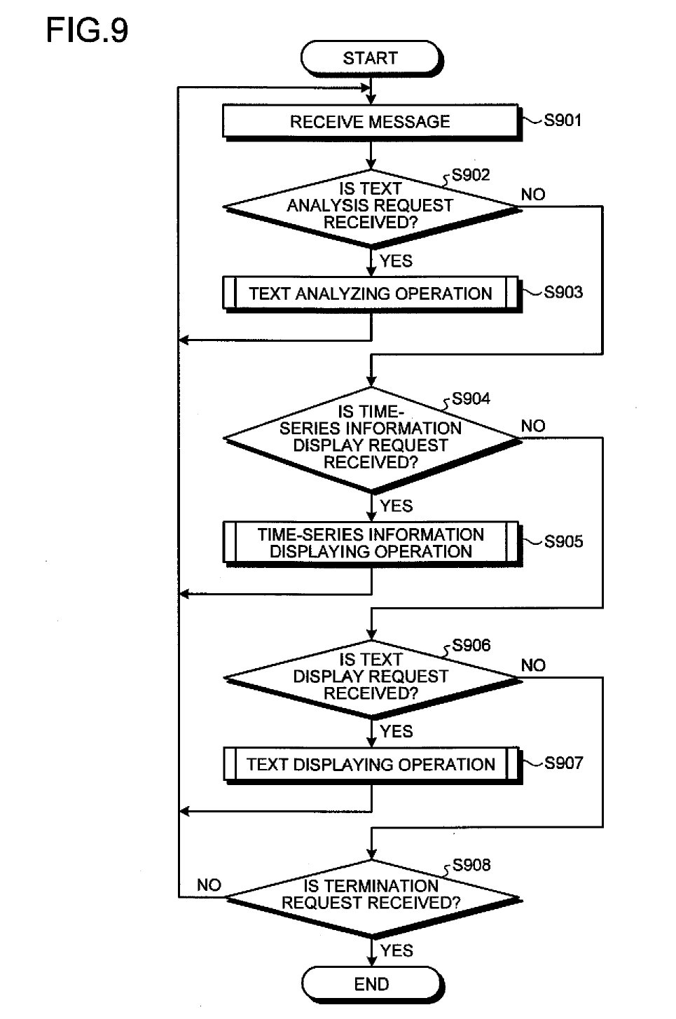

In the embodiment, according to a flowchart illustrated in FIG. 9, the time-series information generating apparatus 1 performs system processing. Herein, FIG. 9 is a flowchart for explaining the sequence of operations performed during system processing in the time-series information generating apparatus according to the embodiment. In the time-series information generating apparatus 1 of the embodiment, the MPU 102 performs system processing by following instructions of a host application, which is a module for controlling, in entirety, the operations of the time-series information generating apparatus 1 and which is stored in the system memory 104.

Once the time-series information generating apparatus 1 is switched ON, the MPU 102 receives a message from the communication device 110 or the input device 114 via the input-output interface 106, and checks the received message (S901). Then, the MPU 102 determines whether or not the received message is a text analysis request that is issued to request generation of text analysis information (such as the time series information specified in the time-series information data 707 illustrated in FIG. 7) from the sentences in the sentence data 205 (S902). If the received message is determined to be a text analysis request (Yes at S902), then the MPU 102 performs a text analyzing operation for generating text analysis information from the sentence data 205 stored in advance in the text data 200 (S903). In the embodiment, the text analyzing operation is performed when the received message is determined to be a text analysis message. Alternatively, without waiting for the reception of a text analysis request, it is possible to perform the text analyzing operation with respect to the text data 200 stored in the system memory 104. Meanwhile, the details regarding the text analyzing operation are given later.

On the other hand, if the received message is not a text analysis request (No at S902), then the MPU 102 determines whether or not the received message is a time-series information display request that is issued to request display of the time-series information data 707 (see FIG. 7) that is generated during the text analyzing operation (S904). If the received message is determined to be a time-series information display request (Yes at S904), the MPU 102 performs a time-series information displaying operation to display the time-series information data 707 generated during the text analyzing operation (S905). Meanwhile, the details regarding the time-series information displaying operation are given later.

On the other hand, if the received message is not a time-series information request (No at S904), then the MPU 102 determines whether or not the received message is a text display request that is issued to request display of the sentence data 205 that is stored in advance in the text data 200 (S906). If the received message is a text display request (Yes at S906), then the MPU 102 performs a text displaying operation for displaying the sentence data 205 stored in advance in the text data 200 (S907). Meanwhile, the details regarding the text displaying operation are given later.

However, if the received message is not a text display request (No at S906), then the MPU 102 determines whether or not the received message is a termination request that is issued to request termination of the system of the time-series information generating apparatus 1 (S908). If the received message is determined to be a termination request (Yes at S908), then the MPU 102 terminates the system of the time-series information generating apparatus 1 and then disconnects the power of the time-series information generating apparatus 1. On the other hand, if the received message is not a termination request (No at S908), the MPU 102 waits for the reception of a new message.

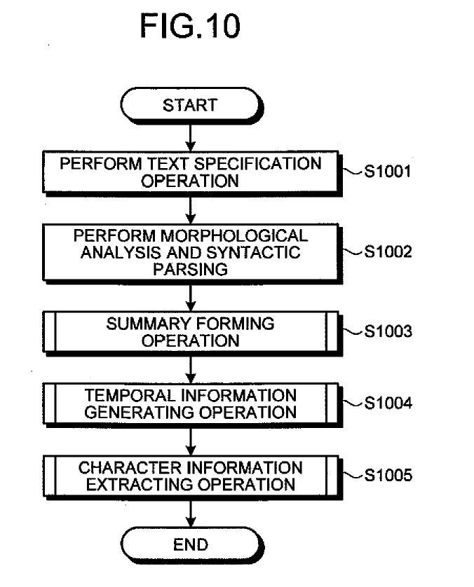

Explained below with reference to FIG. 10 is the text analyzing operation performed by the MPU 102. FIG. 10 is a flowchart for explaining the sequence of operation during the text analyzing operation performed in the time-series information generating apparatus according to the embodiment.

First, the MPU 102 performs a text specification operation for receiving input, from the book number data 201, about an electronic book containing those sentences in the sentence data 205 on which is performed the text analyzing operation from among the sentences specified in the sentence data 205 stored in the text data 200 (S1001).

Subsequent to the text specification operation, the MPU 102 reads, from the text data 200, a plurality of such sets of sentences from the sentence data 205 which are stored in a corresponding manner with that electronic document in the book number data 201 which has been received as input. the MPU 102 performs morphological analysis and syntactic parsing on the sentences that are read from the sentence data 205, and extracts words from the sentences read from the sentence data 205 (S1002). The sentences read from the sentence data 205 are obtained by dividing the text of the electronic book. In the embodiment, it is assumed that the text of an electronic book is divided in a plurality of sets of sentences on a paragraph-by-paragraph basis.

The MPU 102 refers to the result of the morphological analysis and the syntactic parsing, and performs following operations: a summary forming operation for forming summaries in the summary data 705 (see FIG. 7) on a chapter-by-chapter basis from the sentences in the sentence data 205 (S1003); a temporal information generating operation for extracting words representing date information from the sentences read from the sentence data 205 and generating time-series information in the time-series information data 707 (see FIG. 7) regarding the sentences read from the sentence data 205 (S1004); and a character information extracting operation for extracting, from the sentences read from the sentence data 205, the subjects or objects representing character information such as character names specified in the character name data 706 (see FIG. 7) (S1005).

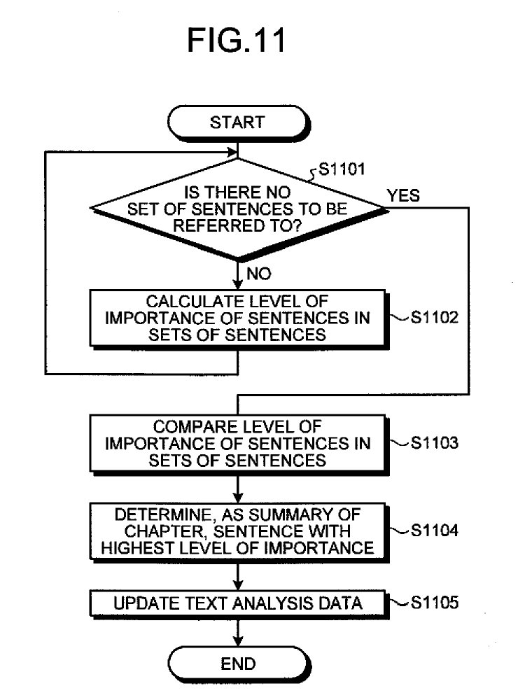

Explained below with reference to FIG. 11 is the summary forming operation performed by the MPU 102. FIG. 11 is a flowchart for explaining the sequence of operations during the summary forming operation performed in the time-series information generating apparatus according to the embodiment.

Regarding the sentences read from the sentence data 205 of the text data 200, the MPU 102 initializes the level of importance to “0”. In the embodiment, it is assumed that, in the RAM 103, the MPU 102 stores in advance the level of importance of the sentences read from the sentence data 205.

First, from among the sentences read from the sentence data 205 of the text data 200, the MPU 102 refers to the sentences corresponding to the chapter number “1” in the chapter number data 203 and the paragraph number “1” in the paragraph number data 204 (S1101). Then, in the word data 302 stored in the word importance data 300, the MPU 102 searches for the words extracted from those sentences which have been referred to in the sentence data 205. Subsequently, the MPU 102 adds the levels of importance of the sentences which have been referred to in the sentence data 205, and stores in the RAM 103 the added value as the level of importance of the sentences which have been referred to in the sentence data 205 (S1102). Once all sentences in the sentence data 205 that correspond to the paragraph number “1” in the paragraph number data 204 are referred to and subjected to calculation of the level of importance, the MPU 102 performs the same operations of referring to those sentences in the sentence data 205 that correspond to the chapter number “1” in the chapter number data 203 and to the paragraph numbers “2” and “3”, respectively, in the paragraph number data 204, and calculates the level of importance (No at S1101, S1102). Once all sentences in the sentence data 205 that correspond to the chapter number “1” in the chapter number data 203 are referred to and subjected to calculation of the level of importance, the MPU 102 performs the same operations of referring to those sentences in the sentence data 205 that correspond to the chapter numbers “2” to “6”, respectively, in the chapter number data 203.

Once all sentences in the sentence data 205 that correspond to the chapter numbers “2” to “6”, respectively, in the chapter number data 203 are referred to and subjected to calculation of the level of importance, and if there is no sentence to be referred to (Yes at S1101), the MPU 102 first compares the levels of importance of those sentences in the sentence data 205 that correspond to the chapter number “1” in the chapter number data 203 (S1103). Then, from among those sentences in the sentence data 205 that correspond to the chapter number “1” in the chapter number data 203, the MPU 102 finds the sentence of highest level of importance (e.g., “Upon finishing the meal, AAAA suddenly stabs CCCC to death with a knife”) and determines that sentence to be the summary of the chapter identified by the chapter number “1” in the chapter number data 203 (S1104). Subsequently, the MPU 102 updates the text analysis data 700 illustrated in FIG. 7 (S1105). More particularly, in the summary data 705 of the text analysis data 700, the MPU 102 stores the summary determined for the chapter number “1” in the chapter number data 703. Moreover, as the paragraph number that is specified in the paragraph number data 704 and that corresponds to the chapter number “1” specified in the chapter number data 703 of the text analysis data 700, the MPU 102 stores the paragraph number “1” that is specified in the paragraph number data 204 and that corresponds to the sentence determined as the summary in the summary data 705. That completes updating of the text analysis data 700. Regarding the chapter numbers “2” to “6”, respectively, in the chapter number data 203, the MPU 102 performs the operations from S1103 to S1105. Once the operations from S1103 to S1105 are performed with respect to all chapter numbers in the chapter number data 203, the MPU 102 ends the summary forming operation.

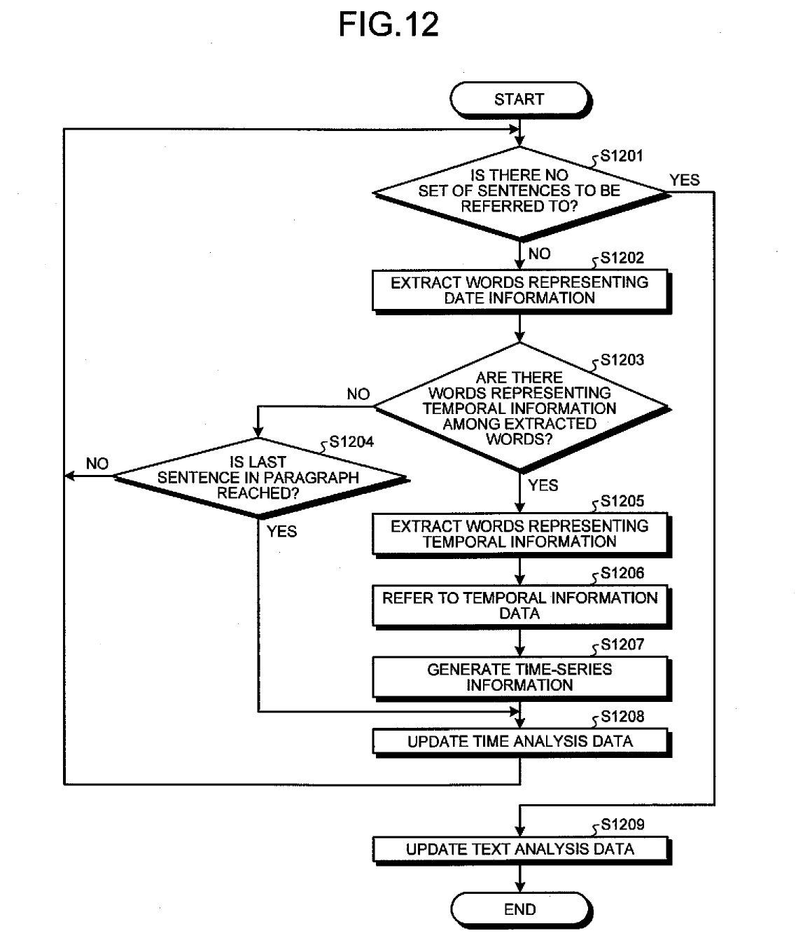

Explained below with reference to FIG. 12 is the temporal information generating operation performed by the MPU 102. FIG. 12 is a flowchart for explaining the sequence of operations during the temporal information generating operation performed in the time-series information generating apparatus according to the embodiment.

First, from among the sentences read from the sentence data 205 of the text data 200, the MPU 102 refers to the sentences corresponding to the paragraph number “1” in the paragraph number data 204 (S1201). Subsequently, from among the words extracted from those sentences in the sentence data 205 which correspond to the paragraph number “1” in the paragraph number data 204, the MPU 102 extracts words representing temporal information (S1202). Moreover, the MPU 102 refers to the temporal information data illustrated in FIG. 4 and determines whether or not there exist words representing temporal information among the words extracted from those sentences in the sentence data 205 which correspond to the paragraph number “1” in the paragraph number data 204 (S1203). As far as extraction of words representing temporal information and determination of whether or not words representing temporal information are present is concerned, the MPU 102 performs those operations till the last sentence in the paragraph (the sentence data 205) identified by the paragraph number “1” in the paragraph number data 204 (No at S1204). Once extraction of words representing temporal information and determination of whether or not words representing temporal information are present is performed for the last sentence in the paragraph identified by the paragraph number “1” in the paragraph number data 204 (Yes at S1204), and when it is determined that there are no words representing temporal information among the words extracted from those sentences in the sentence data 205 which correspond to the paragraph number “1” in the paragraph number data 204 (Yes at S1203). The MPU 102 then updates the time analysis data 500 illustrated in FIG. 5 (S1208). More particularly, the MPU 102 generates “+0” as the time-series information of the sentences in the sentence data 205 corresponding to the paragraph number “1” in the paragraph number data 204, and stores “+0” in the time-series information data 504 in a corresponding manner to the paragraph number “1” in the paragraph number data 503 of the time analysis data 500. Moreover, the MPU 102 stores “−” in the date information data 505 in a corresponding manner to the paragraph number “1” in the paragraph number data 503 of the time analysis data 500. That completes updating of the time analysis data 500.

Subsequently, from among the sentences read from the sentence data 205 of the text data 200, the MPU 102 refers to the sentences corresponding to the paragraph number “2” in the paragraph number data 204 (S1201). Subsequently, from among the words extracted from those sentences in the sentence data 205 which correspond to the paragraph number “2” in the paragraph number data 204, the MPU 102 extracts words representing temporal information (S1202). Moreover, the MPU 102 refers to the temporal information data illustrated in FIG. 4 and determines whether or not there exist words representing temporal information among the words extracted from those sentences in the sentence data 205 which correspond to the paragraph number “2” in the paragraph number data 204 (S1203). As far as extraction of words representing temporal information and determination of whether or not words representing temporal information are present is concerned, the MPU 102 performs those operations till the last sentence in the paragraph (the sentence data 205) identified by the paragraph number “2” in the paragraph number data 204 (No at S1204). Once extraction of words representing temporal information and determination of whether or not words representing temporal information are present is performed for the last sentence in the paragraph identified by the paragraph number “2” in the paragraph number data 204 (Yes at S1204), and when it is determined that there are no words representing temporal information among the words extracted from those sentences in the sentence data 205 which correspond to the paragraph number “2” in the paragraph number data 204 (Yes at S1203). Then, the MPU 102 updates the time analysis data 500 illustrated in FIG. 5 (S1208). More particularly, if the paragraph identified by the paragraph number “2” in the paragraph number data 204 is not the first paragraph of the chapter identified by the chapter number “1” in the chapter number data 203, the MPU 102 refers to the time analysis data 500 and, as the time-series information of the paragraph identified by the paragraph number “2” in the paragraph number data 204, generates the time-series information that has been generated for the sentences in the sentence data 205 corresponding to the previous paragraph to the paragraph identified by the paragraph number “2” in the paragraph number data 503 (i.e., stores “+0” in the time-series information data 504 in a corresponding manner to the paragraph number “1” in the paragraph number data 503). Then, the MPU 102 stores “+0” in the time-series information data 504 in a corresponding manner to the paragraph number “2” in the paragraph number data 503 of the time analysis data 500. Moreover, the MPU 102 stores “−” in the date information data 505 in a corresponding manner to the paragraph number “2” in the paragraph number data 503 of the time analysis data 500. That completes updating of the time analysis data 500.

From among the sentences read from the sentence data 205 of the text data 200, the MPU 102 refers to the sentences corresponding to the paragraph number “3” in the paragraph number data 204 (S1201). Subsequently, from among the words extracted from those sentences in the sentence data 205 which correspond to the paragraph number “3” in the paragraph number data 204, the MPU 102 extracts words representing date information (S1202). Moreover, the MPU 102 refers to the temporal information data 400 illustrated in FIG. 4 and determines whether or not there exist words representing temporal information among the words extracted from those sentences in the sentence data 205 which correspond to the paragraph number “3” in the paragraph number data 204 (S1203). If no words representing date information are extracted, but it is determined that there are words representing temporal information among the words extracted from those sentences in the sentence data 205 which correspond to the paragraph number “3” in the paragraph number data 204 (No at S1203), from the words extracted from those sentences in the sentence data 205 which correspond to the paragraph number “3” in the paragraph number data 204, the MPU 102 extracts “around that time” as the word representing temporal information (S1205). Then, in the temporal information data 403 of the temporal information data 400 illustrated in FIG. 4, the MPU 102 identifies “+0” corresponding to “around that time” that is the extracted word from the word data 402 (S1206). By making use of “+0” identified in the temporal information data 403, the MPU 102 generates “+0” as the time-series information (S1207). Then, the MPU 102 updates the time analysis data 500 illustrated in FIG. 5 (S1208). More particularly, the MPU 102 stores “+0”, which is generated as the time-series information in the time-series information data 504, in a corresponding manner to the paragraph number “3” in the paragraph number data 503 of the time analysis data 500. Moreover, the MPU 102 stores “−” in the date information data 505 in a corresponding manner to the paragraph number “3” in the paragraph number data 503 of the time analysis data 500. That completes updating of the time analysis data 500.

Subsequently, from among the sentences in the sentence data 205 that are read from the text data 200, the MPU 102 refers to the sentences corresponding to the paragraph number “4” in the paragraph number data 204 (S1201). Subsequently, from among the words extracted from those sentences in the sentence data 205 which correspond to the paragraph number “4” in the paragraph number data 204, the MPU 102 extracts “October 2” as the word representing date information (S1202). Moreover, the MPU 102 refers to the temporal information data 400 illustrated in FIG. 4 and determines whether or not there exist words representing temporal information among the words extracted from those sentences in the sentence data 205 which correspond to the paragraph number “4” in the paragraph number data 204 (S1203). When it is determined that there are words representing temporal information among the words extracted from those sentences in the sentence data 205 which correspond to the paragraph number “4” in the paragraph number data 204 (No at S1203). Then, from the words extracted from those sentences in the sentence data 205 which correspond to the paragraph number “4” in the paragraph number data 204, the MPU 102 extracts “two weeks ago” as the word representing temporal information (S1205). Then, in the temporal information data 403 of the temporal information data 400 illustrated in FIG. 4, the MPU 102 identifies “−two weeks” corresponding to “two weeks ago” that is the extracted word from the word data 402 (S1206). By making use of “−two weeks” that is identified in the temporal information data 403, the MPU 102 generates “−two weeks” as the time-series information (S1207). Then, the MPU 102 updates the time analysis data 500 illustrated in FIG. 5 (S1208). More particularly, the MPU 102 stores “two weeks ago” generated as the time-series information in the time-series information data 504 corresponding to that sentence in the sentence data 205 which is identified by the paragraph number “4” in the paragraph number data 503 of the time analysis data 500. Moreover, the MPU 102 stores “October 2” in the date information data 505 in a corresponding manner to the paragraph number “4” in the paragraph number data 503 of the time analysis data 500. That completes updating of the time analysis data 500. Regarding those sentences in the sentence information which correspond to the paragraph numbers “5” to “11”, respectively, in the paragraph number data 204, the MPU 102 performs extraction of words representing date information, generation of time-series information, and updating of the time analysis data 500.

However, if it is confirmed that words representing temporal information are not present in the sentences in the sentence data 205 corresponding to the paragraph number “10” in the paragraph number data 204 that identifies the first paragraph of the chapter identified by the chapter number “6” in the chapter number data 203, and if time-series information is not generated for those sentences in the sentence data 205 which belong to the first paragraph of the chapter identified by the chapter number “6” in the chapter number data 203 (i.e., if the time-series information in the time-series information data 504 is blank for the paragraph number “10” in the paragraph number data 503). Then, as the time-series information of those sentences in the sentence data 205 which correspond to the paragraph number “10” in the paragraph number data 204, the MPU 102 generates that time-series information in the time-series information data 504 which has been generated for those sentences in the sentence data 205 which correspond to the paragraph number “11” in the paragraph number data 204 identifying the next paragraph to the first paragraph of the chapter identified by the chapter number “6” in the chapter number data 203. Then, the MPU 102 stores the time-series information that has been generated in the time-series information data 504 in a corresponding manner with the paragraph number “10” in the paragraph number data 503 of the time analysis data 500.

On the other hand, if the time-series information is not generated also regarding the sentences in the sentence data 205 that correspond to the paragraph number “11” in the paragraph number data 204. Then, as the time-series information of those sentences in the sentence data 205 which correspond to the paragraph numbers “10” and “11” in the paragraph number data 204, the MPU 102 generates the time-series information that has been generated for the sentences in the sentence data 205 corresponding to the last paragraph in the previous chapter to the chapter identified by the chapter number “6” in the chapter number data 203. Then, the MPU 102 stores the time-series information that has been generated in the time-series information data 504 in a corresponding manner to the paragraph numbers “10” and “11” in the paragraph number data 503 of the time analysis data 500.

Once all sentences in the sentence data 205 are referred to and when no more sentences are to be referred to (Yes at S1201), then the MPU 102 updates the text analysis data 700 illustrated in FIG. 7 (S1209). More particularly, the MPU 102 stores the time-series information data 504 of the time analysis data 500 in the time-series information data 707 for those paragraph numbers in the paragraph number data 704 which correspond to the book number, from among the book numbers in the book number data 702 of the text analysis data 700, that matches the book number in the book number data 502 of the time analysis data 500.

Moreover, in the date information data 708 for those sentences in the sentence data 205 which belong to the paragraphs identified by such paragraph numbers in the paragraph number data 704 which correspond to the book numbers specified in the book number data 702 of the text analysis data 700, the MPU 102 stores such date information in the date information data 505 of the time analysis data 500 in which are stored significant values (i.e., values other than “−”). Once the date information data 505 of the time analysis data 500 is stored in the date information data 708 of the text analysis data 700, the MPU 102 refers to the time-series information data 707 and the date information data 708 stored in the text analysis data 700, calculates the information in the date information data 708 that is not stored in the date information data 505 of the time analysis data 500, and stores that date information in the text analysis data 700.

For example, from among the time-series information data 707 stored in the text analysis data 700, the MPU 102 refers to “October 2” that is a significant value in the date information data 708 and refers to “−two weeks” as that time-series information in the time-series information data 707 which corresponds to “October 2” in the date information data 708 (i.e., the MPU 102 refers to the time-series information of those sentences for which the time-series information is generated and from which are extracted expressions representing date information). Subsequently, from “+0” in the time-series information data 707 corresponding to the paragraph number “2” in the paragraph number data 704, the MPU 102 subtracts “−two weeks” as that time-series information in the time-series information data 707 which corresponds to the paragraph number “4” in the paragraph number data 704 (i.e., subtracts the time-series information of those sentences for which the time-series information is generated and from which expressions representing date information are not extracted) and calculates “+two weeks” as the difference (“+0”−(“−two weeks”)). Then, to “October 2” in the date information data 708 corresponding to the paragraph number “4” in the paragraph number data 704 (i.e., to the date information of those sentences for which the time-series information is generated and from which are extracted expressions representing date information), the MPU 102 adds the calculated difference of “+two weeks” and calculates “October 16” as the date information in the date information data 708 corresponding to the paragraph number “2” in the paragraph number data 704 (i.e., calculates date information of those sentences for which the time-series information is generated and from which expressions representing date information are not extracted). Subsequently, in the text analysis data 700, the MPU 102 stores “October 16” in the date information data 708 in a corresponding manner to the paragraph number “2” in the paragraph number data 704.

Moreover, from “−one week” that is the time-series information in the time-series information data 707 corresponding to the paragraph number “6” in the paragraph number data 704, the MPU 102 subtracts “−two weeks” as the time-series information in the time-series information data 707 corresponding to the paragraph number “4” in the paragraph number data 704 and calculates “+one week” as the difference (“−one week”−(“−two weeks”)). Then, to “October 2” in the date information data 708 corresponding to the paragraph number “4” in the paragraph number data 704, the MPU 102 adds the calculated difference of “+one week” and calculates “October 9” as the date information in the date information data 708 corresponding to the paragraph number “6” in the paragraph number data 704. Subsequently, in the text analysis data 700, the MPU 102 stores “October 9” in the date information data 708 in a corresponding manner to the paragraph number “6” in the paragraph number data 704. In an identical manner, the MPU 102 also calculates the date information in the date information data 708 corresponding to the paragraphs numbers “7” and “9” in the paragraph number data 704, and stores that date information in the text analysis data 700. However, if significant values are not stored as all date information in the date information data 708 of the text analysis data 700, then the MPU 102 sets “−” for all date information in the date information data 708 of the text analysis data 700.

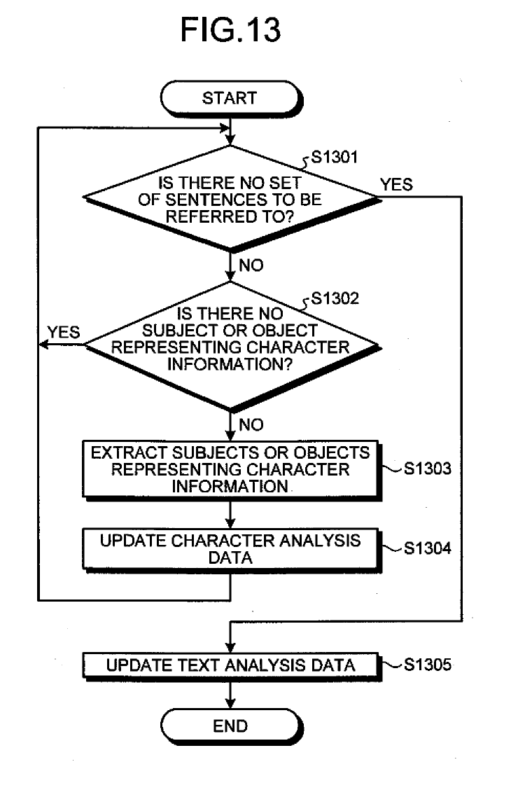

Explained below with reference to FIG. 13 is the character information extracting operation performed by the MPU 102. FIG. 13 is a flowchart for explaining the sequence of operations during the character information extracting operation performed in the time-series information generating apparatus according to the embodiment.

First, the MPU 102 refers to those sentences in the sentence data 205 which are read from the text data 200 in a corresponding manner to the paragraph number “1” in the paragraph number data 204 (No at S1301). Then, the MPU determines whether or not subjects or objects representing character information are present among the words that are extracted from the first sentence from among those sentences in the sentence data 205 which correspond to the paragraph number “1” in the paragraph number data 204 (S1302). If no subjects or objects representing character information are present among the words that are extracted from the first sentence from among those sentences in the sentence data 205 which correspond to the paragraph number “1” in the paragraph number data 204 (Yes at S1302), then the MPU 102 refers to the next sentence from among those sentences in the sentence data 205 which correspond to the paragraph number “1” in the paragraph number data 204 (No at S1301).

If “AAAA” is present as a subject representing character information among the words extracted from the first sentence from among those sentences in the sentence data 205 which correspond to the paragraph number “1” in the paragraph number data 204 (No at S1302), then the MPU 102 extracts “AAAA” as a subject representing character information (S1303). Then, the MPU 102 updates the character analysis data 600 illustrated in FIG. 6 by storing “AAAA”, which is extracted as a subject representing character information, in the character name data 604 corresponding to the paragraph number “1” in the paragraph number data 603 (S1304).

Subsequently, the MPU 102 refers to the second sentence in the sentence data 205 corresponding to the paragraph number “1” in the paragraph number data 204 (No at S301). If “CCCC” is present as a subject representing character information among the words that are extracted from the second sentence in the sentence data 205 corresponding to the paragraph number “1” in the paragraph number data 204 (No at S1302), then the MPU 102 extracts “CCCC” as a subject representing character information (S1303). Then, the MPU 102 updates the character analysis data 600 illustrated in FIG. 6 by additionally storing “CCCC”, which is extracted as a subject representing character information, in the character name data 604 corresponding to the paragraph number “1” in the paragraph number data 603 (S1304). In an identical manner, from the other sentences in the sentence data 205 corresponding to the paragraph number “1” in the paragraph number data 204, the MPU 102 extracts subjects or objects representing character information and accordingly updates the character analysis data 600. However, the character analysis data 600 is not updated if the subjects or objects representing character information that are extracted from the other sentences in the sentence data 205 corresponding to the paragraph number “1” in the paragraph number data 204 are already stored in the character name data 604 in a corresponding manner to the paragraph number “1” in the paragraph number data 603. Once all such sentences in the sentence data 205 which correspond to the paragraph number “1” in the paragraph number data 204 are referred to, then the MPU 102 refers to those sentences in the sentence data 205 which correspond to the paragraph number “2” in the paragraph number data 204 (No at S1301).

If “AAAA” and “CCCC” are present as subjects representing character information among the words extracted that are from the first sentence from among those sentences in the sentence data 205 which correspond to the paragraph number “2” in the paragraph number data 204 (No at S1302), then the MPU 102 extracts “AAAA” and “CCCC” as subjects representing character information (S1303). Then, the MPU 102 updates the character analysis data 600 illustrated in FIG. 6 by storing “AAAA” and “CCCC”, which are extracted as subjects representing character information, in the character name data 604 corresponding to the paragraph number “2” in the paragraph number data 603 (S1304).

Moreover, if “CCCC” which is a subject or an object representing character information is present among the words extracted from the second sentence in the sentence data 205 corresponding to the paragraph number “2” in the paragraph number data 204 (No at S1302), then the MPU 102 extracts “CCCC” as a subject or an object representing character information (S1303). Then, the MPU 102 refers to the character name data 604 corresponding to the paragraph number “2” in the paragraph number data 603 of the character analysis data 600. However, since “CCCC” is already stored in the character name data 604 of the character analysis data 600, the MPU 102 does not newly store “CCCC” that has been extracted as a subject or an object representing character information. Once all those sentences in the sentence data 205 which correspond to the paragraph number “2” in the paragraph number data 204 are referred to, the MPU 102 refers to such sentences in the sentence data 205 which correspond to the paragraph number “3” in the paragraph number data 204 (No at S1301).

If “BBBB” is present as a subject representing character information among the words that are extracted from the first sentence in the sentence data 205 corresponding to the paragraph number “3” in the paragraph number data 204 (No at S1302), then the MPU 102 extracts “BBBB” as a subject representing character information (S1303). Subsequently, the MPU 102 updates the character analysis data 600 illustrated in FIG. 6 by storing “BBBB”, which is extracted as a subject representing character information, in the character name data 604 corresponding to the paragraph number “3” in the paragraph number data 603 (S1304).

If “DDDD” is present as a subject representing character information among the words that are extracted from the second sentence in the sentence data 205 corresponding to the paragraph number “3” in the paragraph number data 204 (No at S1302), then the MPU 102 extracts “DDDD” as a subject representing character information (S1303). Subsequently, the MPU 102 updates the character analysis data 600 illustrated in FIG. 6 by storing “DDDD”, which is extracted as a subject representing character information, in the character name data 604 corresponding to the paragraph number “3” in the paragraph number data 603 (S1304).

If “BBBB” is present as a subject representing character information among the words that are extracted from the third sentence in the sentence data 205 corresponding to the paragraph number “3” in the paragraph number data 204 (No at S1302), then the MPU 102 extracts “BBBB” as a subject representing character information (S1303). Subsequently, the MPU 102 refers to the character name data 604 corresponding to the paragraph number “3” in the paragraph number data 603 of the character analysis data 600. However, since “BBBB” is already stored in the character name data 604 of the character analysis data 600, the MPU 102 does not newly store “BBBB” that has been extracted as a subject or an object representing character information. Once all those sentences in the sentence data 205 which correspond to the paragraph number “3” in the paragraph number data 204 are referred to, the MPU 102 extracts subjects or objects representing character information from each of the paragraph numbers “4” to “11” in the paragraph number data 204 and accordingly updates the character analysis data 600.

Once all sentences in the sentence data 205 that are read from the text data 200 are referred to and when no more sentences are to be referred to (Yes at S1301), then the MPU 102 updates the text analysis data 700 illustrated in FIG. 7 (S1305). More particularly, for those paragraph numbers in the paragraph number data 704 which correspond to the book number, from among the book numbers in the book number data 702 of the text analysis data 700, that matches the book number in the book number data 602 of the character analysis data 600, the MPU 102 stores the character name data 604 of the character analysis data 600 in the character name data 706. Until the character name data 604 of the character analysis data 600 is stored in the character name data 706 for all paragraph numbers in the paragraph number data 704 which correspond to the book number, from among the book numbers in the book number data 702 of the text analysis data 700, that matches the book number in the book number data 602 of the character analysis data 600, the MPU 102 repeats the updating operation.

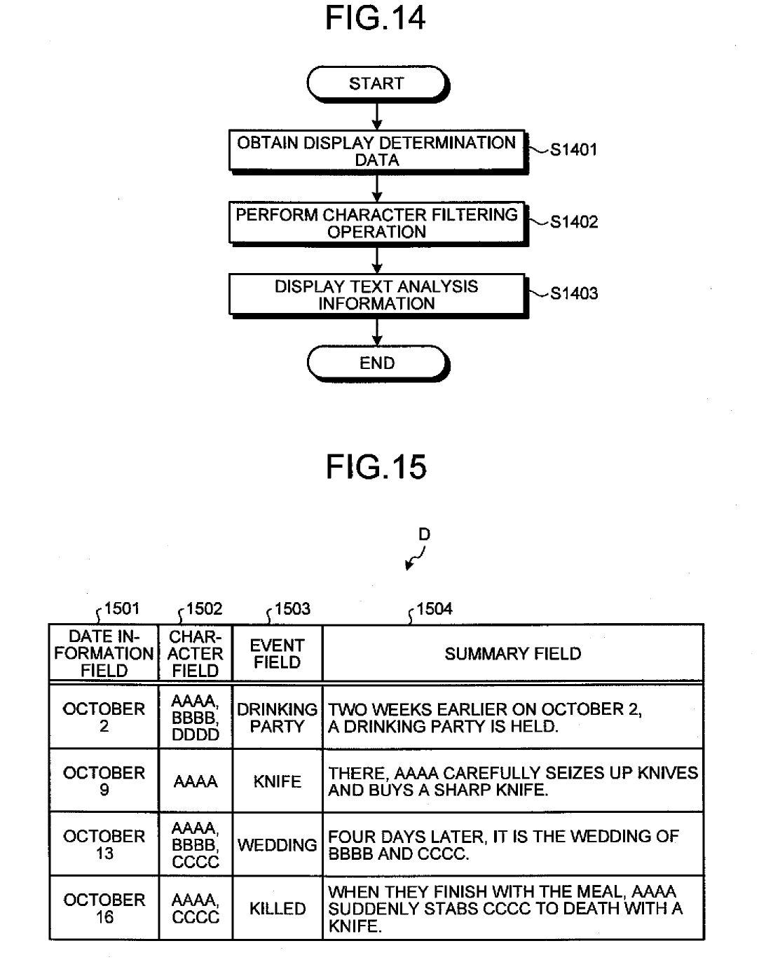

Explained below with reference to FIGS. 14 to 18 is a time-series information displaying operation performed by the MPU 102. FIG. 14 is a flowchart for explaining the sequence of operations during the time-series information displaying operation performed in the time-series information generating apparatus according to the embodiment. FIGS. 15 to 18 are illustration diagrams of examples of screens on which text analysis information is displayed.

When a message containing a time-series information display request is received, the MPU 102 obtains the display determination data 802 from the character filtering setting data 800 (S1401). Then, the MPU 102 performs a character filtering operation in which it is determined to display the information related to only “AAAA”, since it is specified in the character name data 803 in a corresponding manner to “display” status in the display determination data 802 (S1402).

Subsequently, from the text analysis data 700 illustrated in FIG. 7, the MPU 102 extracts the serial numbers “1” to “4” specified in the serial number data 701 in a corresponding manner to the character names specified in the character name data 706, which also include “AAAA” that is specified in the character name data 803 and determined to be displayed during the character filtering operation. Then, in the text analysis data 700, the MPU 102 confirms whether or not significant values are set in the date information specified in the date information data 708 in a corresponding manner to the serial numbers “1” to “4” extracted from the serial number data 701. If it is confirmed that significant values are set in the date information specified in the date information data 708 in a corresponding manner to the serial numbers “1” to “4” extracted from the serial number data 701, the MPU 102 determines that, from among the date information specified in the date information data 708 in a corresponding manner to the serial numbers “1” to “4” extracted from the serial number data 701, the oldest date information “October 2” is to be displayed as the first display item, and extracts the serial number “2” specified in the serial number data 701 corresponding to the date information “October 2” in the date information data 708. Then, from the text analysis data 700, the MPU 102 reads the text analysis information (i.e., the summary data 705, the character name data 706, and the date information data 708) corresponding to the serial number “2” extracted from the serial number data 701.

Subsequently, from among the date information specified in the date information data 708 in a corresponding manner to the serial numbers “1” to “4” extracted from the serial number data 701, the MPU 102 determines that the second oldest date information “October 9” is to be displayed as the second display item, and extracts the serial number “3” specified in the serial number data 701 corresponding to the date information “October 9” in the date information data 708. Then, from the text analysis data 700, the MPU 102 reads the text analysis information (i.e., the summary data 705, the character name data 706, and the date information data 708) corresponding to the serial number “3” extracted from the serial number data 701. In an identical manner, regarding the date information “October 16” and “October 13” specified in the date information data 708 in a corresponding manner to the serial numbers “1” and “4”, respectively, the MPU 102 determines “October 13” to be the third display item and determines “October 16” to be the fourth display item. Then, from the text analysis data 700, the MPU 102 reads the text analysis information corresponding to the serial numbers “1” and “4” extracted from the serial number data 701.

As illustrated in FIG. 15, according to the display order determined regarding the date information specified in the date information data 708 in a corresponding manner to the serial numbers “1” to “4” in the serial number data 701 (i.e., according to the time-series information specified in the time-series information data 707 in a corresponding manner to the serial numbers “1” to “4” in the serial number data 701), the MPU 102 displays on the display device 112 a screen D in which the text analysis information that has been read is displayed collectively (S1403). In the embodiment, as illustrated in FIG. 15, the MPU 102 displays the date information data 708 read from the text analysis data 700 in a date information field 1501, displays the character name data 706 read from the text analysis data 700 in a character field 1502, displays the words of highest level of importance, from among the words included in the summary data 705 read from the text analysis data 700, in an event field 1503, and displays the summary data 705 read from the text analysis data 700 in a summary field 1504. Thus, the MPU 102 displays in a corresponding manner the summary data 705, the character name data 706, and the date information data 708 read from the text analysis data 700. Because of that, the summaries in the summary data 705 of those sentences in the sentence data 205 which are included only in the time-series information data 707 can be displayed with the date information data 708 appended thereto. That helps the user in deepening the understanding. Meanwhile, while selecting the words of highest level of importance that are to be displayed in the event field 1503, the MPU 102 refers to the word importance data 300 illustrated in FIG. 3 and selects the words of highest level of importance from the words included in the summaries specified in the summary data 705.

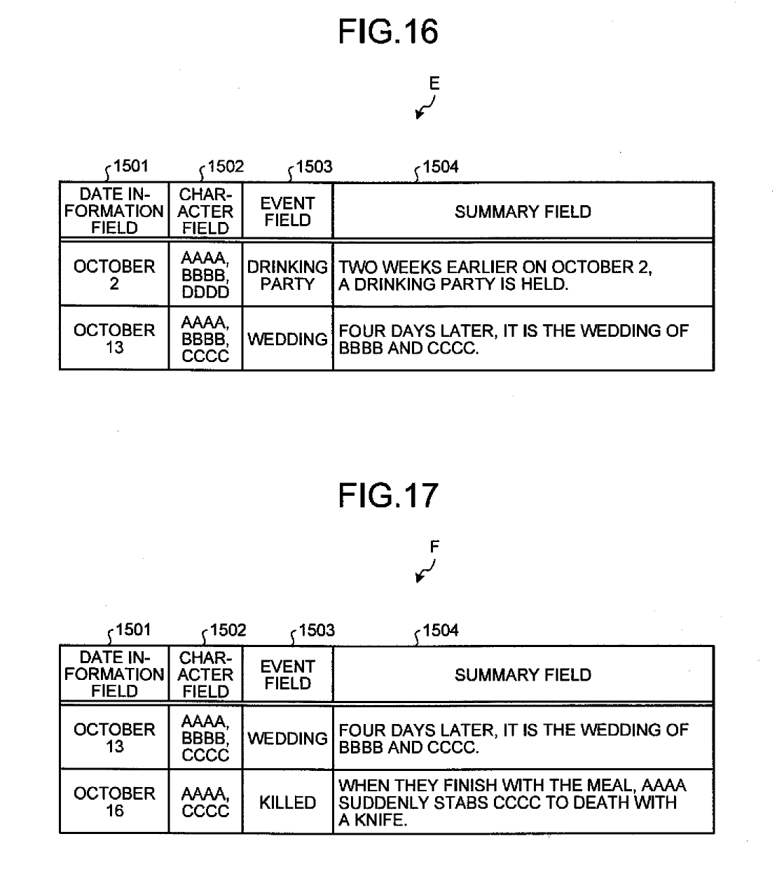

Moreover, even in the case when “BBBB” or “CCCC” is the character name specified in the character name data 803 in a corresponding manner to the “display” status in the display determination data 802 obtained from the character filtering setting data 800, the operations from S1401 to S1403 are performed in an identical manner and a screen E illustrated in FIG. 16 or a screen F illustrated in FIG. 17 is illustrated. In this way, from among the summaries specified in the summary data 705, it is possible to display the summary from the perspective of each character appearing in the sentences specified in the sentence data 205. That helps the user in deepening the understanding.

However, upon extracting the serial numbers from the serial number data 701 in a corresponding manner to the character names that are determined from among the character names in the character name data 803 during the character filtering operation. If the date information in the date information data 708 corresponding to the extracted serial numbers in the serial number data 701 does not have significant values, then the MPU 102 displays a screen in which the date information data 708 is replaced with the time-series information data 707 corresponding to the extracted serial numbers in the serial number data 701.

For example, if, at S1402 in the character filtering operation, it is determined to display the information related to only “AAAA” that is specified in the character name data 803. Then, from the serial number data 701 of the text analysis data 700, the MPU 102 extracts the serial numbers “1” to “4” corresponding to such sets of character names in the character name data 706 which include “AAAA” that is determined to be the character name to be displayed from the character name data 803. Then, the MPU 102 confirms whether or not significant values are set in the date information specified in the date information data 708 in a corresponding manner to the serial numbers “1” to “4” extracted from the serial number data 701 of the text analysis data 700. If it is confirmed that significant values are not set in the date information specified in the date information data 708 in a corresponding manner to the serial numbers “1” to “4” extracted from the serial number data 701, the MPU 102 determines that, from among the time-series information specified in the time-series information data 707 in a corresponding manner to the serial numbers “1” to “4” extracted from the serial number data 701, the oldest time-series information “−two weeks” is to be displayed as the first display item, and extracts the serial number “2” specified in the serial number data 701 corresponding to the time-series information “−two weeks” in the time-series information data 707. Then, from the text analysis data 700, the MPU 102 reads the text analysis information (i.e., the summary data 705, the character name data 706, and the time-series information data 707) corresponding to the serial number “2” extracted from the serial number data 701. In an identical manner, regarding the serial numbers “1”, “3”, and “4” extracted from the serial number data 701, the MPU 102 performs determination of display order and reading of text analysis information.

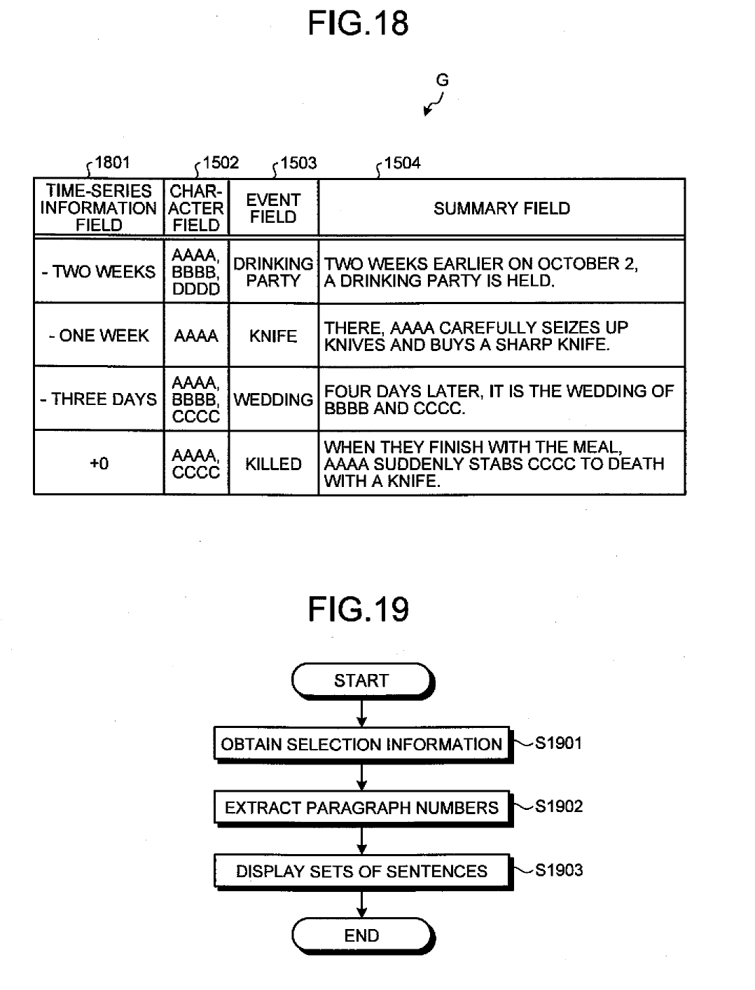

Then, as illustrated in FIG. 18, according to the order determined regarding the time-series information specified in the time-series information data 707 in a corresponding manner to the serial numbers “1” to “4” in the serial number data 701, the MPU 102 displays on the display device 112 a screen G in which the text analysis information that is read from the text analysis data 700 is displayed collectively. In the embodiment, as illustrated in FIG. 18, from among the text analysis information read from the text analysis data 700, the MPU 102 displays the time-series information data 707 in a time-series information field 1801, displays the character name data 706 in the character field 1502, displays the words of highest level of importance, from among the words included in the summary data 705, in the event field 1503, and displays the summary data 705 in the summary field 1504. Meanwhile, while selecting the words of highest level of importance that are to be displayed in the event field 1503, the MPU 102 refers to the word importance data 300 illustrated in FIG. 3 and selects the words of highest level of importance from the words included in the summaries specified in the summary data 705.

Thus, in the present embodiment, the MPU 102 displays such text analysis information in which the summary data 705, the character name data 706, the date information data 708 (or the time-series information data 707), and the words (events) displayed in the event field 1503 are stored in a corresponding manner. However, as long as the text analysis information is displayed collectively according to the time-series information, it is also possible to display such text analysis information in which, in place of the summary data 705, the events and the date information data 708 are stored in a corresponding manner. Moreover, in the present embodiment, the text analysis information is displayed in ascending order of the text analysis information corresponding to old time-series information in the time-series information data 707. However, alternatively, it is also possible to display the text analysis information in descending order of the text analysis information corresponding to new time-series information in the time-series information data 707.

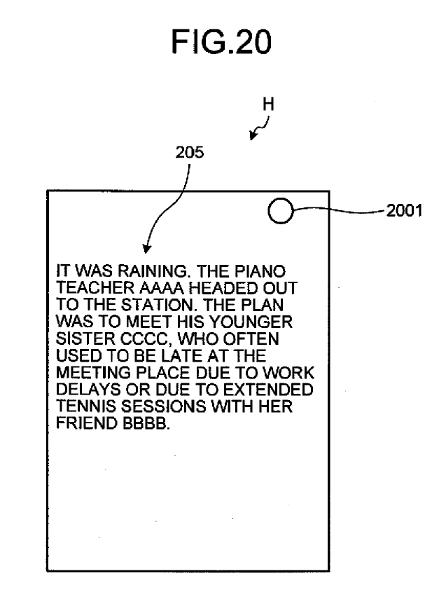

Explained below with reference to FIG. 19 and FIG. 20 is the text displaying operation performed by the MPU 102. FIG. 19 is a flowchart for explaining the sequence of operations during the text displaying operation performed in the time-series information generating apparatus according to the embodiment. FIG. 20 is an illustration diagram of an example of a screen in which the text of an electronic book is displayed.

While the screen D, E, F, or G of the text analysis information are displayed on the display device 112, if the user operates the input device 114 (or gives spoken commands) in order to select at least a single set of the text analysis information (the summary data 705) from among the text analysis information (the summary data 705) displayed on the screen D, E, F, or G (or if a received message contains an instruction to display the text analysis information that is selected from the text analysis information stored in the text analysis data 700), the MPU 102 obtains selection information that indicates the text analysis information selected from the text analysis information displayed on the screen D, E, F, or G (S1901).

Subsequently, the MPU 102 obtains the summary field 1504 included in the text analysis information that is indicated by the selection information that has been obtained and extracts such paragraph numbers from the paragraph number data 704 which correspond to those summaries obtained from the text analysis data 700 which match the summaries in the summary field 1504 (S1902). Then, from the text data 200 illustrated in FIG. 2, the MPU 102 reads those sentences from the sentence data 205 which correspond to such paragraphs in the paragraph number data 204 which match the extracted paragraph numbers from the paragraph number data 704 (i.e., reads those sentences from which are determined the summaries that are obtained from the text analysis data), and, as illustrated in FIG. 20, displays on the display device 112 a screen H showing the sentences read from the sentence data 205 (S1903). Hence, just by selecting a summary from the summary data 705 displayed on the screen D, E, F, or G, it is possible to display those sentences in the sentence data 205 from which is determined the summary selected from the summary data 705. That helps the user in deepening the understanding.

When a plurality of summaries are selected from the summary data 705 displayed on the screen D, E, F, or G, the MPU 102 refers to the time-series information corresponding to the selected summaries and collectively displays those sentences in the sentence data 205 from which is determined each summary selected from the summary data 705. Thus, the sentences in the sentence data can be displayed in chronological order. That helps the user in deepening the understanding.

In the present embodiment, the MPU 102 display the screen H with a button 2001 that allows returning to the screen D, E, F, or G showing the text analysis information containing not only the sentences read from the sentence data 205 but also the date information data 708 (or the time-series information data 707). When the button 2001 on the screen H is pressed by means of operating the input device 114, the MPU 102 displays on the display device 112 the screen D, E, F, or G showing the text analysis information. Moreover, in the embodiment, although the button 2001 on the screen H is pressed to instruct the MPU 102 to return to the screens D, E, F, and G from the screen H, it is alternatively also possible to issue a spoken command for returning to the screens D, E, F, and G from the screen H. Furthermore, in the embodiment, although the screen D, E, F, or G is displayed separately from the screen H, it is also possible to display the screen H along with the screen D, E, F, or G.

In this way, in the time-series information generating apparatus 1 of the embodiment, the text of an electronic book to be displayed is divided in a plurality of sets of sentences on a paragraph-by-paragraph basis in the sentence data 205. Then, from each divided set of sentences in the sentence data 205, a summary is formed in the summary data 705. Moreover, the time-series information data 707 is generated that represents relative temporal information between the first set of sentences specified in the sentence data 205 and the other sets of sentences specified in the sentence data 205. According to the time-series information that has been generated, the summary, specified in the summary data 705, of each divided set of sentences in the sentence data 205 is collectively displayed so as to allow analysis of the text of the electronic book to be displayed. Since the time-series information is generated automatically, even if the time-series information is not set in advance for each set of sentences in the sentence data 205, the summaries in the summary data 705 can still be collectively displayed according to the time-series information generated automatically for each set of sentences in the sentence data. That helps the user in deepening the understanding as well as helps in enhancing the entertainment values.

The computer program executed on the time-series information generating apparatus 1 of the embodiment may be stored in advance in the system memory 104 such as a ROM or the like.

The computer program may also be provided as being stored in a computer-readable recording medium such as a compact disk read only memory (CD-ROM), a flexible disk (FD), a compact disk readable (CD-R), or a digital versatile disk (DVD) in the form of an installable or executable file.

Further, the computer program may be stored in a computer connected via a network such as the Internet so that it can be downloaded via the network. The computer program may be provided or distributed over a network such as the Internet.

Meanwhile, the computer program executed on the time-series information generating apparatus 1 of the embodiment comprises modules that implement various operations described above (e.g., a text analyzing module configured to perform the text analyzing operation illustrated at S903 in FIG. 9, a time-series information displaying module configured to perform the time-series information displaying operation illustrated at S905 in FIG. 9, and a text displaying module configured to perform the text displaying operation illustrated at S907 in FIG. 9). As real hardware, a CPU (processor) loads the computer program from the ROM into a main memory and executes it to implement the above modules. Thus, the functions of the text analyzing module, the time-series information displaying module, and the text displaying module are implemented on the main memory device.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A time-series information generating apparatus comprising:
a dividing module configured to divide an electronic document into one or more sets of sentences for display;
a determining module configured to determine a summary of each of the sets of sentences;
a generating module configured to generate time-series information that represents relative temporal information between any one of the sets of sentences and another set of sentences the sets of sentences; and
a display module configured to collectively display the summary of each of the sets of sentences according to the time-series information.

2. The time-series information generating apparatus of claim 1, further comprising an extracting module configured to:
refer to temporal information data, the temporal information data comprising a word representing the temporal information; and
extract a word representing temporal information from each of the sets of sentences, wherein
the generating module is configured to generate the time-series information.

3. The time-series information generating apparatus of claim 1, further comprising:
a date information extracting module configured to extract a word from each of the sets of sentences, the word representing date information; and
a calculating module configured to calculate a time-series information of the set of sentences where the time-series information is generated and a word representing the date information is not extracted by adding a difference between the time-series information of a set of sentences where a word representing the date information is extracted to a time-series information of a set of sentences where a word representing the date information is not extracted.

4. The time-series information generating apparatus of claim 2, wherein
the dividing module is configured to divide the electronic document in one or more sets of sentences on a paragraph-by-paragraph basis,
the generating module is configured to generate the time-series information of a next paragraph as the time-series information of a first paragraph preceding the next paragraph, if no word representing the temporal information is extracted from the first paragraph from among the paragraphs, and
the generating module is configured to generate the time-series information of a paragraph previous to the other paragraph as the time-series information of the other paragraph if no word representing the temporal information is extracted from another paragraph than the first paragraph.

5. The time-series information generating apparatus of claim 3, wherein the display module is configured to display the summary of each of the sets of sentences in association with a word representing the date information extracted from the set of sentences.

6. The time-series information generating apparatus of claim 1, further comprising a selection module configured to select at least one summary from among summaries of the sets of sentences displayed by the display module, wherein
the display module is configured to display a set of sentences corresponding to the summary selected by the selection module.

7. The time-series information generating apparatus of claim 3, further comprising a character information extracting module configured to extract a subject or an object identifying character information from each of the sets of sentences, wherein
the display module is configured to display the summary of each of the sets of sentences, the word representing the date information extracted from the set of sentences, and the subject or the object identifying the character information in association with one another.

8. The time-series information generating apparatus of claim 7, further comprising a character setting module configured to set character information to be displayed by the display module, wherein
the display module is configured to display, from among summaries of the sets of sentences, a summary of a set of sentences that contains the subject or the object representing the character information that matches the character information set by the character setting module.

9. The time-series information generating apparatus of claim 6, wherein the display module is configured to display the sets of sentences based on the time-series information.

10. A time-series information generating method implemented using a time-series information generating apparatus comprising a dividing module, a determining module, a generating module, and a display module, the method comprising:
dividing, using the dividing module, an electronic document to be displayed into one or more sets of sentences;
determining, using the determining module, a summary of each of the sets of sentences;
generating, using the generating module, time-series information that represents relative temporal information between any one of the sets of sentences and another set of sentences; and
displaying, using the display module, the summary of each of the sets of sentences in a collective manner according to the time-series information.
